(19) United States
(12) Patent Application Publication
(10) Pub. No.: US 2023/0071722 A1
(43) Pub. Date: Mar. 9, 2023

(54) ANALOG DEMODULATION OF PHASE MODULATED CONTINUOUS WAVE (PMCW) LiDAR

(71) Applicant: Seagate Technology LLC, Fremont, CA (US)

(72) Inventors: Daniel Joseph Klemme, Robbinsdale, MN (US); Walter R. Eppler, Cranberry Township, PA (US)

(21) Appl. No.: 17/899,126

(22) Filed: Aug. 30, 2022

Related U.S. Application Data
(60) Provisional application No. 63/240,597, filed on Sep. 3, 2021.

(51) Int. Cl. G01S 7/4913; G01S 17/32; G01S 17/93

(52) U.S. Cl. CPC G01S 7/4913; G01S 17/32; G01S 17/93

(57) ABSTRACT

Method and apparatus for generating and processing pulses in a light detection and ranging (LiDAR) system. In some embodiments, an emitter outputs phase modulated continuous wave (PMCW) light sequences encoded with a selected encoding scheme such as a pseudo-random bit sequence (PRBS). An analog processing circuit processes reflected light sequences from a target illuminated by the PMCW light sequences by performing analog extraction of a doppler component and analog encoding correlation prior to digitalization of the received signal. The analog processing circuit can include a plurality of demodulation stages each multiplying the input signals by positive and negative magnitudes of a scalar value at times corresponding to signal transitions of different associated doppler clock frequencies. A threshold circuit applies suitable thresholding, after which the signals can be digitized by an analog-to-digital converter (ADC) for further processing in the digital domain to obtain range information associated with the detected target.

### RELATED APPLICATION

The present application makes a claim of domestic priority to U.S. provisional patent application No. 63/240,597 filed Sep. 3, 2021, the contents of which are hereby incorporated by reference.

### SUMMARY

Various embodiments of the present disclosure are generally directed to a method and apparatus for generating and processing pulses in a light detection and ranging (LiDAR) system.

Without limitation, some embodiments provide an emitter which outputs phase modulated continuous wave (PMCW) light sequences encoded with a selected encoding scheme such as a pseudo-random bit sequence (PRBS). An analog processing circuit processes reflected light sequences from a potential target illuminated by the PMCW light sequences by performing analog extraction of a doppler component and analog encoding correlation prior to digitalization of the received signal.

The analog processing circuit can include a plurality of demodulation stages each multiplying the input signals by positive and negative magnitudes of a scalar value at times corresponding to signal transitions of a different associated doppler clock frequency. A threshold circuit applies suitable thresholding, after which the signals are digitized by an analog-to-digital converter (ADC) for further processing in the digital domain to obtain range information associated with the detected target.

These and other features and advantages of various embodiments can be understood from a review of the following detailed description in conjunction with a review of the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIG. 2 is a simplified functional representation of an emitter constructed and operated in accordance with some embodiments to emit phase modulated continuous wave (PMCW) pulse sequences.

FIG. 3 represents a field of view (FoV) generated by the emitter of FIG. 2 in some embodiments.

FIG. 4 is a functional block representation of a detector configured to decode information from the FoV of FIG. 3 in accordance with various embodiments.

FIG. 5 shows a standard demodulation sequence that utilizes digital signal processing in accordance with the related art.

FIG. 6 shows an analog demodulation sequence that utilizes analog processing in accordance with various embodiments of the present disclosure.

FIG. 7 is a functional representation of an analog processing circuit in accordance with FIG. 4 that operates in accordance with various embodiments.

FIG. 8 is a functional block representation of another LiDAR system that emits and processes PMCW pulse sequences in accordance with further embodiments.

FIG. 9 is a processing sequence to illustrate operations carried out by the system of FIG. 1 in accordance with various embodiments.

FIG. 10 is a functional block representation of an adaptive analog processing manager constructed and operated in accordance with further embodiments of the present disclosure.

### DETAILED DESCRIPTION

Various embodiments of the present disclosure are generally directed to optimization of an active light detection system.

Light Detection and Ranging (LiDAR) systems are useful in a number of applications in which range information (e.g., distance, velocity, etc.) regarding a target is detected by irradiating the target with electromagnetic radiation in the form of light. The range information is determined in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1550 nm or more). Other wavelength ranges can be used.

There are a number of ways in which the emitted light from a LiDAR system can be emitted and detected. Examples include coherent, incoherent, pulsed wave, frequency modulated continuous wave (FMCW), phase modulated continuous wave (PMCW), and others.

A PMCW LiDAR system applies phase encoding to a continuous wave light beam to determine range and velocity of a given target. A PMCW based system generally operates to change the phase of the transmitted signal according to a certain pattern or code, sometimes referred to as the spreading code. The transmitted signal can be phase modulated by mixing a baseband signal with a local oscillator to generate a transmitted signal with a phase that is changed corresponding to the baseband signal. The phase may be modulated using a random signal from a random number generator (RNG) source, a cyclical pseudo-random signal from a pseudo-random bit sequence (PRBS) source, or from some Other modulation source.

For a single transmitter, a sequence of phase values that form the spreading code that has good autocorrelation properties is usually utilized to minimize ghost targets in the received signal. The rate at which the phase is modulated determines the bandwidth of the transmitted signal and is called the chip rate.

In a PMCW based LiDAR system, the detector (receiver) performs correlations of the received signal with time-delayed versions of the transmitted signal and searches for peaks in the correlation. The time-delay of the transmitted signal that yields peaks in the correlation corresponds to the delay of the transmitted signal when reflected off of a down range target. The distance to the target can be determined based on the time delay and the speed of light in the applicable medium. The phase encoding usually requires decoding in order to make an accurate determination of the range information, and this can be confounded by the addition of a doppler component induced by the velocity of the target.

Existing generation PMCW LiDAR systems tend to perform such decoding at the detector stage by digitizing the received signal at a high sample rate and applying digital signal processing operations such as via a digital signal processor (DSP) or other digital circuitry. While operable, this can require the use of a fast, high sample rate analog to digital converter (ADC) as well as a complex digital processor to perform fast and real-time computations.

Accordingly, various embodiments of the present disclosure are directed to an apparatus and method for performing detection decoding of a phase modulated continuous wave (PMCW) LiDAR signal using an analog regime. In some embodiments, analog processing is provided, after which the resulting data may be converted to a digital form and fed into a DSP or other digital processing circuitry for downstream analysis (e.g., a visualizer, an artificial intelligence neural network, etc.).

Instead of performing high sample rate digitalization of the input data, the bulk of the signal processing of the PMCW input data is carried out by various embodiments in the analog domain using specially configured analog processing circuitry. All of the processing can be completed in the analog domain so that the resulting range information is obtained using the analog processing circuitry, or the results of the analog processing stage can be fed forward via an ADC into digital processing circuitry for further processing to arrive at the range information. Analog domain processing as described herein provides certain advantages and efficiencies, including the ability to capture and/or filter frequency spectra that would otherwise normally be filtered out by the upstream digitalization step.

While not limiting, it is contemplated that the various embodiments enable ADC speeds to be reduced in range from hundreds of MHz (10⁶ Hz) or more, to tens of MHz or less. It is further contemplated that such analog decoding techniques described herein can enhance processing speed and resolution, facilitate higher bandwidth, reduce circuit complexity, cost and power consumption levels, as well as provide other benefits.

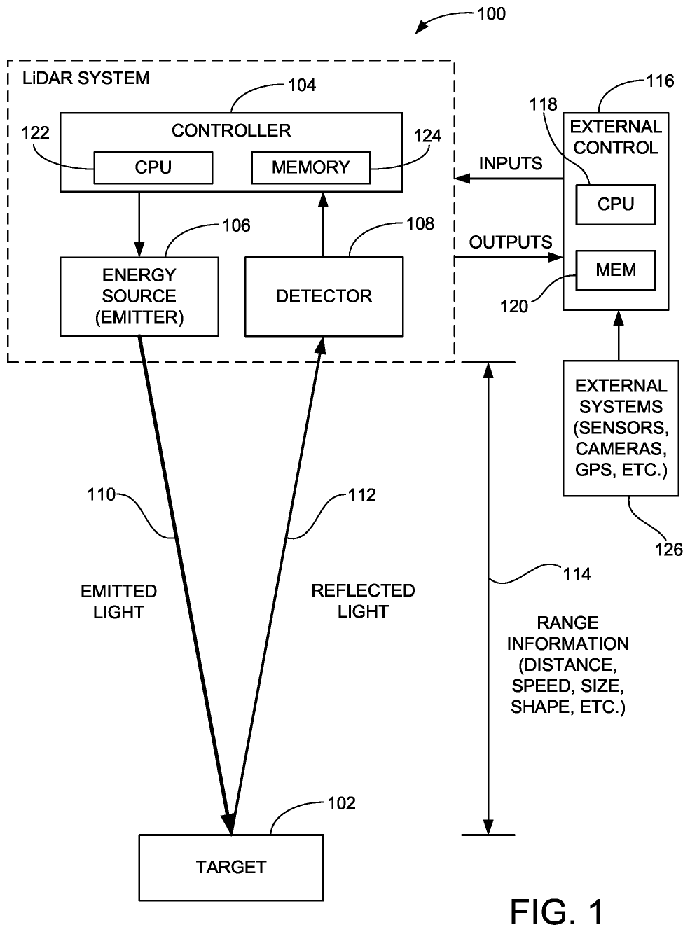

These and other features can be understood beginning with a review of FIG. 1, which shows a light detection and ranging (LiDAR) system constructed and operated in accordance with various embodiments. The LiDAR system 100 is configured to obtain range information regarding a target 102 that is a physical element located distal from the system 100. The range information can be beneficial for a number of areas and applications including but not limited to topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 represents the actual, true range information associated with the intervening distance (or other range parameter) between the LiDAR system 100 and the target 102. Depending on the configuration of the system, the range information can include the relative or absolute speed, velocity, direction, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external control system 116 for further processing and/or use.

In some cases, inputs supplied by the external control system 116 can activate and configure the system 100 to capture particular range information, which is then returned to the system 116 by the controller 104. The external system 116 can take any number of suitable forms, and may include a system controller (such as CPU 118), local memory 120, etc. The external system 116 may form a portion of a closed-loop control system and the range information output by the LiDAR system 100 can be used by the external system 116 to adjust the position of a moveable element.

As noted above, the controller 104 can take a number of forms. In some embodiments, the controller 104 incorporates one or more programmable processors (CPU) 122 that execute program instructions in the form of software/firmware stored in a local memory 124, and which communicate with the external controller 118.

An additional number of systems 126 can provide information to the external control system 116 and/or the LiDAR system 100. The external systems 126 can take any number of forms including but not limited to environmental sensors (e.g., temperature sensors, moisture sensors, timers, ambient light level sensors, ice detectors, etc.), cameras, geopositioning systems (e.g., global positioning systems, GPS), radar systems, proximity sensors, speedometers, etc.

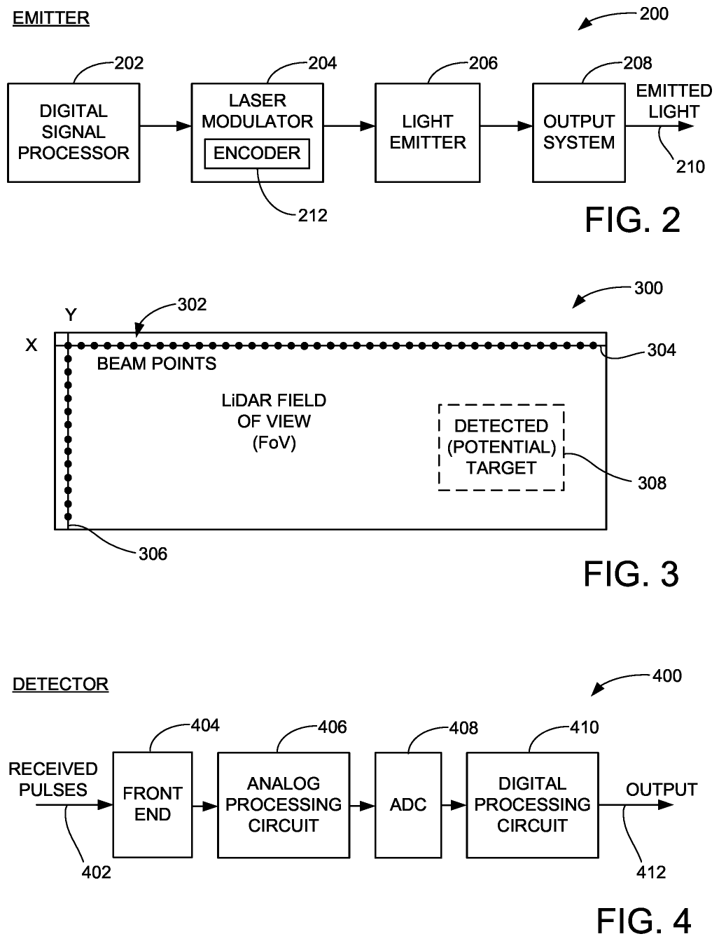

FIG. 2 depicts an emitter circuit 200 incorporated into the system 100 of FIG. 1 in some embodiments. Other arrangements can be used so the configuration of FIG. 2 is merely illustrative and is not limiting. The emitter circuit 200 includes a digital signal processor (DSP) 202 that provides adjusted inputs to a laser modulator 204, which in turn adjusts a light emitter 206 (e.g., a laser, a laser diode, etc.) that emits electromagnetic radiation (e.g. light) in a desired spectrum.

The emitted light is processed by an output system 208 to issue a beam of emitted light 210 in a desired scanning pattern. The output system 208 can take a variety of forms including but not limited to a rotatable polygon, a solid-state array, a micro-mirror device, etc. It is contemplated that the emitted light will be in the form of phase modulated continuous wave (PMCW) light that is scanned by the output system 208 along one or multiple axial directions. As such, the PMCW light may be phase modulated using an encoder block 212, which encodes information into the output light sequences emitted by the system.

The encoder 212 may take a variety of forms based on the requirements of a given application. In some embodiments, the encoder 212 is a pseudo-random bit sequence (PRBS) generator which generates a pseudo-random bit sequence generated deterministically from a predetermined polynomial function. The signals may be periodic in nature so that one period of the PRBS can be selected to correspond to each LiDAR point beam in the sequence, although such is not necessarily required.

Other forms of encoding can be applied by the encoder 212, however, so that the various embodiments presented herein are not necessarily limited to PRBS encoding. In other embodiments, a random number generator (RNG) source can be used to provide each emitted beam point sequence with a unique code, predetermined sequences can be stored and used as required, etc. The manner in which the PMCW pulses are generated can vary and is not limiting. In some cases, the phase is shifted in a binary manner from 0 to π and the sequence of bits is randomly adjusted in relation to the PRBS or other encoding mechanism. In other cases, the output light at a continuous frequency does not necessarily have to have a duty cycle of 100%; rather, the light can be pulsed such as with a 10% duty cycle (on-time), 50% duty cycle, etc. with the phase being modulated within each pulse with the various encoding schemes described above. Other configurations can be used.

FIG. 3 shows an exemplary field of view (FoV) 300 generated by the emitter 200 in accordance with some embodiments. The FoV 300 generally represents that portion of the down range detection area that can be sensed and tracked by the system through the emission and receipt of emitted PMCW light beams.

The FoV 300 in FIG. 3 is generally rectangular in shape and arranged along orthogonal x-y axes. However, this is merely for purposes of illustration and is not limiting. Cartesian arrays are contemplated, but other arrangements can be used including but not limited to spherical or polar coordinates, multidimensional coordinates, single axis coordinates, etc. The FoV is scanned (rasterized) using beam points 302 arranged along respective rows 304 (x-axis) and columns 306 (y-axis). A detected (potential) target within the FoV 300 is generally denoted at 308.

The system 200 of FIG. 2 generates some overall number of beam points per second. This total number may be many hundreds of thousands or even millions of beam points per second. The points are arranged into a succession of frames, with each frame covering the FoV and multiple frames being obtained each second. The particular data rate will depend on a number of factors including the configuration of the system (including the use of one or multiple light sources, etc.). The resulting data can be used to generate a three-dimensional (3D) point cloud representation of the down range environment. Potential targets such as denoted at 308 will be confirmed based on reflected light characteristics obtained from the reflected light within the FoV 300.

FIG. 4 provides a generalized representation of a detector circuit 400 configured to process reflected light from the FoV 300 in FIG. 3 in accordance with some embodiments. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized, as can multiple light sources in the emitter 200 of FIG. 2.

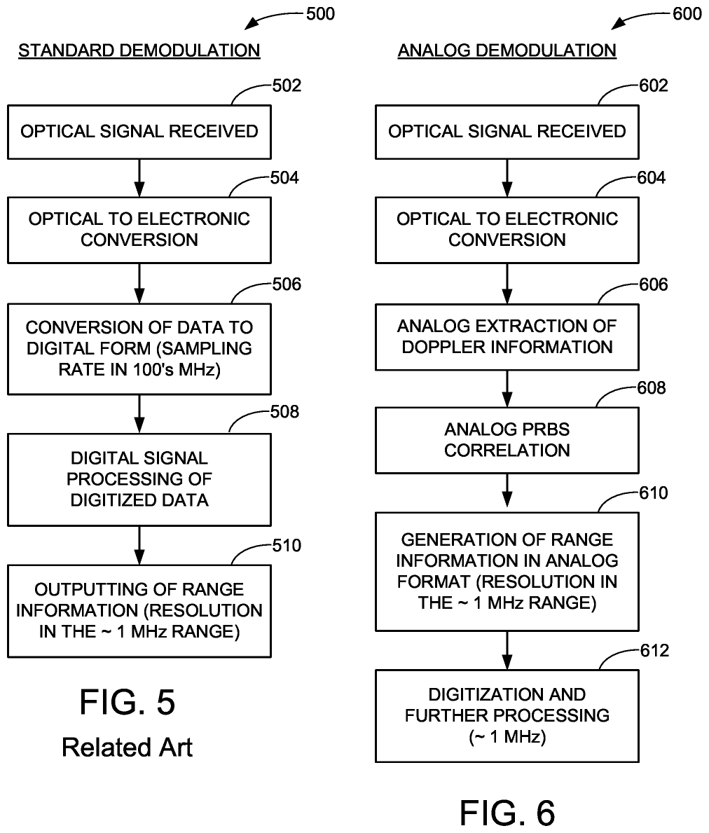

As explained below, the output of the front end 404 is processed by an analog processing circuit 406 which provides processing of the input signals in the analog domain. Once this processing is completed, the output from the analog processing circuit 406 may be converted to digital form using an analog to digital converter (ADC) 410, and this output is in turn further processed by a digital processing circuit 410 such as a DSP as required to generate a useful output 412. Of particular interest is the configuration and operation of the analog processing circuit 406, which will now be discussed with reference to FIGS. 5-6 which illustrate different ways in which PMCW light received by a detector can be processed.

FIG. 5 is a sequence diagram 500 to illustrate a standard demodulation process that can be carried out in accordance with the existing art. The process 500 includes receiving an optical signal back from a downstream target, step 502; processing of the received signal to convert the signal to electronic form, step 504; digitization of the signal including use of a high speed ADC with a sampling rate in the hundreds of MHz or more, step 506; application of digital signal processing to the digitized data such as through the use of a DSP, step 508; and the outputting of range information based on the digital processing of the data, step 510.

It is contemplated albeit not necessarily required that the output range information will have a resolution on the order of about 1 MHz, although other configurations can be used. The upstream digitization of the data will require a significantly higher resolution, such as on the order of 100 MHz or more.

In current generation detectors, it will be understood that PMCW light patterns are encoded, transmitted, received, and digitized prior to substantive processing using various signal processing techniques. As explained above, such current generation processing in the digital domain can include correlation operations of the received signal with time-delayed versions of the transmitted signal (from the emitter) to locate peaks in the correlation response. While operable, such processing has a number of limitations, including loss of resolution due to the sampling rate, the need for expensive and high-powered ADC circuitry, and high powered, complex circuitry to carry out the necessary signal processing.

By contrast, various embodiments of the present disclosure carry out the processing of received PMCW light signals in the analog domain in accordance with FIG. 6, which provides a sequence diagram 600. It will be understood that the sequence 600 provides an overview of processing carried out by the detector circuitry 400 of FIG. 4, and the sequence 600 is merely exemplary and is not limiting.

FIG. 6 shows receipt of an optical signal from a downstream target, step 602; processing of the received signal to convert the signal from optical to electrical form, step 604; performing an analog extraction operation to extract doppler information from the input signal, step 606; performing an analog pseudo-random bit sequence (PRBS) correlation process, step 608; outputting range information in the analog domain, step 610; and subsequent digitization of the output range information such as through the use of an ADC, step 612 for further processing in the digital domain. As before, the output resolution may be on the order of about 1 MHZ, but other ranges can be utilized.

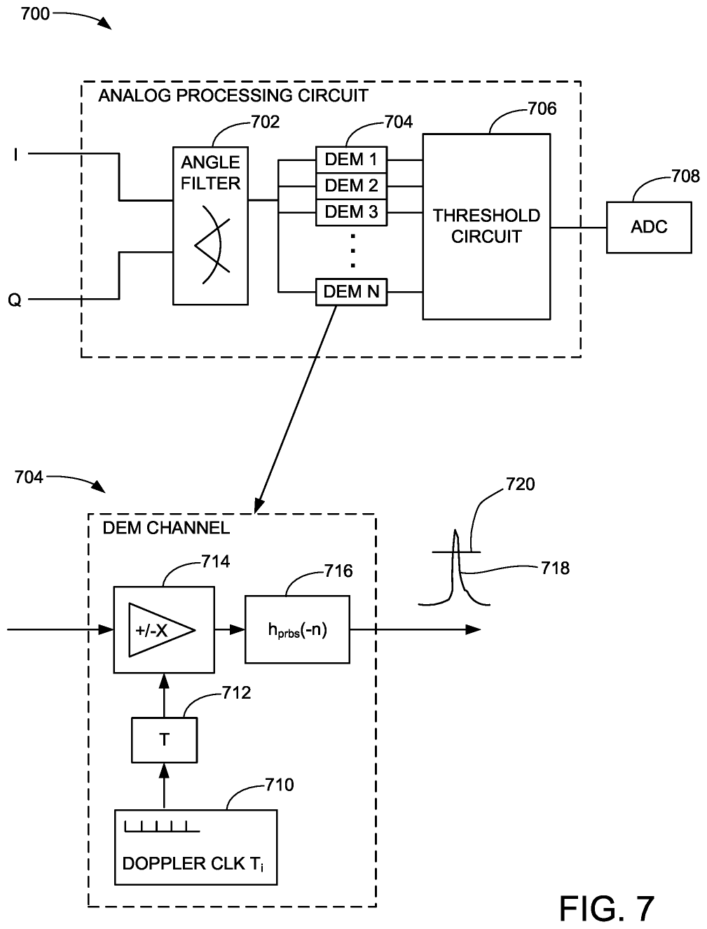

FIG. 7 illustrates an analog processing circuit 700 configured in accordance with various embodiments. The circuit 700 generally corresponds to the analog processing circuit 406 in FIG. 4 and performs various functions set forth in FIG. 6.

The analog processing circuit 700 receives quadrature I and Q inputs obtained using mixer circuits as known in the art and which are provided to an analog filter operator block 702. The block 702 operates as a filter to clean up the signal and reduce non-desired frequency components, so that components of interest are passed on through remaining portions of the circuit.

The filtered signal is next passed to an array of demodulation blocks, also referred to as demodulation (DEM) channels 704. A total of N channels are provided. The number N can be any suitable plural value (e.g., 8, 16, etc.). Each DEM channel 704 can be tuned to a different frequency response, or can have the same demodulation characteristics.

A threshold circuit 706 applies one or more predetermined threshold levels to the outputs of the DEM channels. The output of the threshold circuit 706 is thereafter applied to an ADC 708, generally corresponding to the ADC 408 in FIG. 4 and which digitizes the output data for further digital signal processing (e.g., block 410, FIG. 4).

FIG. 7 shows a general format for a selected one of the DEM channels 704 in accordance with some embodiments. Other configurations can be used so that the circuitry configuration is merely exemplary and is not limiting.

A doppler clock circuit is denoted at 710. This provides a clock signal at a selected frequency with repetitively occurring transitions Tᵢ (such as positive going transitions). The resolution can vary based on different channels and is in a range to enable detection of doppler shift characteristics in the input signal.

The clock 710 is supplied to a timing circuit T 712 which detects each transition Tᵢ and supplies a corresponding input to a multiplier block 714 in response thereto. The multiplier block 714 operates, in conjunction with the clock 710 and circuit 712, such that the input signal is multiplied by respective positive and negative values of a scaler value X at each transition Tᵢ. At times other than the transitions Tᵢ, the output of the multiplier block 714 goes to zero (0). It will be noted that if the actual doppler shift in the input signals (Tdoppler) is equal to Tᵢ, then the circuit is perfectly matched and each input pulse will be multiplied (e.g., when Tdoppler=Tᵢ, then all input pulses will be multiplied by the multiplier 714).

The output of the multiplier block 714 is supplied to an analog correlator block 716 which applies a transfer function h_{PRBS}(−n) to correlate the received output sequence to the input sequence (such as from encoder 212, FIG. 2). This operation results in the detection of valid pulses 718 when such correlation exists. The output pulses 718 are subjected to a suitable predetermined threshold 720 supplied by the threshold circuit 706, with the resulting analog data being passed to the ADC 708 as described above. By providing different demodulation circuits 704 with different doppler clock values, various levels of doppler shift can be detected and passed for further processing. For each channel 704, f_{d}/2 will generally be equal to T_{PRBS}/Tᵢ, where f_{d} is the frequency of the data received at the detector, T_{PRBS} is the time period of the encoding, and Tᵢ is the frequency of the associated doppler clock 710.

As described herein, in contrast to some techniques known in the art, the analog processing circuit 700 may perform doppler removal at very high speeds by alternating the signal along the respective channels at the given frequencies, which may provide valuable enhancements over the existing art (e.g., by potentially reducing ADC speeds to tens of MHz or less, enhancing processing speed and resolution, increasing bandwidth, and/or reducing circuit complexity, cost and power consumption levels).

FIG. 8 shows another representation of aspects of a LiDAR system 800 similar to the system 100 in accordance with further embodiments. A PRBS generator block 802, which can be incorporated into the emitter 200 of FIG. 2 or elsewhere in the system, generates a pseudo-random sequence of bits that are used to modulate a transmitter 804 to provide a PMCW sequence 806 that is phase modulated in relation to the pseudo-random sequence from the PRBS generator 802. As noted above, the bit sequence may be cyclical for each pulse sequence.

The pulse sequence is directed toward a target 808 within the associated FoV (see FIG. 3), and reflected back as a reflected sequence 810 that is received by a receiver 812. The receiver 812 filters and demodulates the received sequence 810 as described above in FIG. 7.

In some cases, the transmitter (emitter) 804 includes a timing circuit 814 which operates to establish a time (e,g, a first time stamp) at which each emitted pulse sequence 806 is emitted. A corresponding timing circuit 816 can be incorporated into the receiver (decoder) 812, which identifies the time (e,g, a second time stamp) when the amplitude threshold circuit (e.g., 706, FIG. 7) is triggered. In this way, the intervening time between the respective first and second time stamps can be used to determine a time of flight (ToF) and associated distance range information regarding the target 808. An ADC can still be used to transfer the decoded range information to the digital stage as required, although such may not necessarily be required.

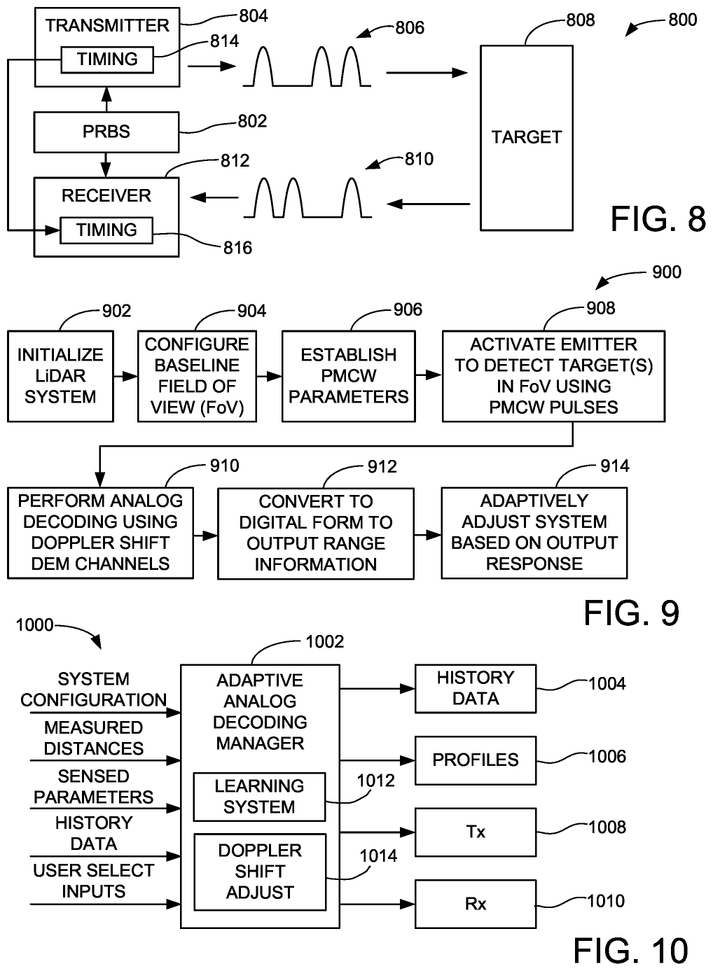

FIG. 9 provides a sequence diagram 900 to illustrate operations that can be carried out as variously embodied by the system of FIGS. 1-4 and 6-8. Other operations can be carried out so that FIG. 9 is merely exemplary and is not limiting.

A system such as 100, 800 is initialized at 902 for operation. The transitioning of the system to an operational state can include the configuration of a baseline FoV, block 904, and the establishment of suitable PMCW parameters, block 906. It will be noted that the PMCW profiles will be specially configured for analog detection as described herein.

The system transitions to normal operation at block 908 in which the emitter (e.g., FIG. 2) is utilized to irradiate the FoV and various potential targets within the FoV are illuminated with reflected light sequences. The received light pulses are processed in the analog domain using doppler shift demodulation (DEM) channels and other aspects described above in FIGS. 6-7, as shown by block 910.

The output data are digitized and processed at block 912 to output the desired range information regarding the potential targets illuminated in block 908. As desired, adaptive adjustments are made to the operation of the system at block 914, including changes in the emitted patterns of PMCW light, threshold levels, clock values, gain values, voltage thresholds, etc. in order to improve detection. As described above, this can include the use of profiles, learning systems, AI, visualization systems, etc.

FIG. 10 provides an adaptive analog decoding system 1000 in accordance with further embodiments. The system 1000 can be realized in hardware and/or via one or more programmable processors, including aspects of the emitter, detector and/or controller of FIG. 1.

The system 1000 includes an adaptive analog decoding manager 1002 which receives various inputs from the system including system configuration information, measured distances, various sensed parameters (both operational and environmental), history data based on previous detections, and various user selectable inputs to enable operation under different operational conditions.

Outputs by the manager circuit 1002 can be supplied to local memory to store history data 1004 and various operational profiles 1006 for different operational modes and conditions. Input control values are further supplied to a transmitter (Tx) 1008, corresponding to the emitters discussed above, and to a receiver (Rx) 1010, corresponding to the detectors discussed above.

In further embodiments, the manager circuit 1002 can include a learning system 1012 that utilizes inputs that can be processed at the digital stage level to assist in target processing, and a doppler shift adjustment circuit 1014 that can adaptively adjust various parameters to enhance operation of the analog domain processing stage.

While various embodiments have contemplated PRBS encoding to differentiate the PMCW sequences, other forms of encoding are contemplated and will be processed in similar fashion. The embodiments herein are contemplated as being particularly suitable for autonomous vehicle systems and related driver assistance guidance systems, but substantially any PMCW application can benefit from the various embodiments disclosed herein.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
an emitter configured to output electromagnetic radiation in the form of phase modulated continuous wave (PMCW) light sequences toward a field of view (FoV) encoded with a selected encoding scheme; and
an analog processing circuit configured to process reflected light sequences from a potential target within the FoV, the analog processing circuit performing analog extraction of a doppler component and analog encoding correlation to the selected encoding scheme prior to digitalization of the received signal.

2. The apparatus of claim 1, wherein the analog processing circuit comprises a plurality of demodulation stages each comprising a multiplier to multiply input signals by a scalar value at times corresponding to signal transitions of an input doppler clock signal operative at a selected doppler clock frequency, the multiplier multiplying said input signals by both positive and negative values of the scalar value.

3. The apparatus of claim 2, wherein each of the plurality of demodulated stages operates in parallel and is provided with a different doppler clock frequency.

4. The apparatus of claim 1, wherein the analog processing circuit further applies a predetermined amplitude threshold to detect pulses output by the encoding correlation operation, and forwards the detected pulses to an analog-to-digital converter (ADC) to convert the pulses to digital form.

5. The apparatus of claim 1, wherein the selected encoding scheme applied to the output sequences is carried out responsive to a pseudo-random bit sequence (PRBS), and wherein the analog encoding correlation is characterized as PRBS correlation.

6. The apparatus of claim 1, wherein a portion of the output light sequences are forwarded to the analog processing circuit.

7. The apparatus of claim 1, further comprising an ADC circuit configured to convert the output of the analog processing circuit to digital form, and a digital signal processor (DSP) which processes an output from the ADC circuit to generate range information associated with a selected target within the FoV.

8. The apparatus of claim 1, further comprising a first timing circuit of the emitter which generates a first time stamp associated with a first time at which a first PMCW light sequence is emitted in a direction toward a target within the FoV, and a second timing circuit of the analog processing circuit which generates a second time stamp associated with a second time at which a threshold circuit detects the first PMCW light sequence reflected from the target, the analog processing circuit further configured to determine a distance from the emitter to the target responsive to an elapsed time interval between the first time identified by the first time stamp and the second time identified by the second time stamp.

9. The apparatus of claim 1, wherein an input to the analog processing circuit comprises I and Q quadrature channel data detected from the FoV.

10. The apparatus of claim 1, further comprising an angle operator circuit configured to apply filtering to the input signals received by the analog processing circuit.

11. The apparatus of claim 1, wherein the analog processing circuit forms a portion of a detector further comprising a front end configured to receive reflected light from the light sequences emitted by the emitter, an ADC circuit configured to convert output values from the analog processing circuit to digital form, a digital processor circuit configured to extract range information, and an adaptive adjustment manager circuit configured to adjust at least one parameter of the system responsive to the extracted range information.

12. The apparatus of claim 1, characterized as a light detection and ranging (LiDAR) system with a light source that outputs the electromagnetic radiation with wavelengths in the range of about 250 nanometers, nm to about 1500 nm.

13. A light detection and ranging (LiDAR) system, comprising:
an emitter comprising:
a light source configured to output electromagnetic radiation;
an encoding circuit configured to encode pulses of the electromagnetic radiation using a pseudo-random bit sequence (PRBS) to generate a phase modulated continuous wave (PMCW) output;
and
an output system configured to rasterize the PMCW output over a predetermined field of view (FoV); and
a detector comprising:
a front end configured to detect reflected light pulses from at least one target within the FoV and convert the light pulses to electrical input signals in an analog form;
an analog processing circuit configured to extract a doppler component and correlate information from the electrical input signals based on the PRBS encoding supplied by the encoding circuit;
an analog-to-digital converter (ADC) circuit configured to convert an analog output from the analog processing circuit to a corresponding sequence of digital signals; and
a digital processing circuit configured to extract range information associated with a target within the FoV based on the sequence of digital signals from the ADC circuit.

14. The LiDAR system of claim 13, wherein the detector further comprises an adaptive analog processing manager circuit which adjusts operation of the analog processing circuit responsive to the extracted range information from the digital processing circuit.

15. The LiDAR system of claim 13, wherein the analog processing circuit comprises a plurality of demodulation stages each comprising a multiplier to multiply input signals by a scalar value at times corresponding to signal transitions of an input doppler clock signal operative at a selected doppler clock frequency, the multiplier multiplying said input signals by both positive and negative values of the scalar value, each of the plurality of demodulation stages operating in parallel and having a different doppler clock frequency.

16. The LiDAR system of claim 15, wherein the analog processing circuit further comprises a threshold circuit configured to apply a predetermined amplitude threshold to detect pulses output by each of the plurality of demodulation stages, and to forward the detected pulses to the ADC circuit to convert the pulses to digital form.

17. A method comprising:
illuminating a target within a field of view (FoV) with light pulses in the form of a phase modulated continuous wave (PMCW) sequence encoded with a selected encoding mechanism;
detecting a corresponding light sequence reflected from the illuminated target;
converting the detected light sequence to an electrical form to provide a corresponding sequence of input analog signals;
demodulating the input analog signals using a scalar multiplier that multiples the input analog signals by positive and negative values of a scalar values at transitions of a predetermined doppler clock signal and multiplying the input analog signals by a value of zero at other times between said transitions to generate multiplied output analog signals;
correlating the multiplied output analog signals with an output corresponding to the selected encoding mechanism to provide correlated output analog signals; and
decoding range information associated with a distance to the target responsive to the correlated output analog signals.

18. The method of claim 17, wherein the decoding of the range information comprises converting the correlated output analog signals from an analog form to a digital form, and decoding the range information using the digital form of the correlated output analog signals.

19. The method of claim 17, wherein the selected encoding mechanism comprises a pseudo-random bit sequence (PRBS).

20. The method of claim 18, wherein the input analog signals are concurrently demodulated using an array of analog demodulation circuits each performing scalar multiplication operations at transitions of different doppler clock signals.
